(19) United States
(12) Patent Application Publication
(10) Pub. No.: US 2019/0204690 A1
(43) Pub. Date: Jul. 4, 2019

(54) COLOR FILTER SUBSTRATE, LCD PANEL AND LCD DEVICE

(71) Applicant: SHENZHEN CHINA STAR OPTOELECTRONICS SEMICONDUCTOR DISPLAY TECHNOLOGY CO., LTD., Shenzhen (CN)

(72) Inventor: Hongmao LIU, Shenzhen (CN)

(21) Appl. No.: 16/001,595

(22) Filed: Jun. 6, 2018

Related U.S. Application Data
(63) Continuation of application No. PCT/CN2018/075562, filed on Feb. 7, 2018.

(30) Foreign Application Priority Data
Dec. 29, 2017 (CN) 201711482411.9

(51) Int. Cl. G02F 1/1343; G02F 1/1335

(52) U.S. Cl. CPC G02F 1/134309; G02F 1/133512

(57) ABSTRACT

The invention provides a CF substrate and an LCD panel. The XF substrate comprises a substrate, and an indium-tin-oxide (ITO) conductive film formed on the substrate; trenches being disposed at edge region of the ITO conductive film, the trenches penetrating the ITO conductive film and dividing the ITO conductive film into a first region and a second region, the first and second regions being mutually insulated. The insulated first and second regions of the CF substrate guarantees the film thickness evenness of the first region so as to guarantee the stable voltage difference of the liquid crystal in the LCD panel for quality display.

### CROSS REFERENCE TO RELATED APPLICATIONS

This application is a continuing application of PCT Patent Application No, PCT/CN2018/075562, entitled “COLOR FILTER SUBSTRATE, LCD PANEL AND LCD DEVICE”, filed on Feb. 7, 2018, which claims priority to Chinese Patent Application No. CN201711482411.9, filed on Dec. 29, 2017, both of which are hereby incorporated in its entireties by reference.

### BACKGROUND OF THE INVENTION

### 1. Field of the Invention

The present invention relates to the field of display, and in particular to the field of color filter substrate, liquid crystal display (LCD) panel and LCD device.

### 2. The Related Arts

The liquid crystal display (LCD) device, with the advantages of high display quality, power-saving, thinness and wide application range, is widely used in various consumer electronic products, such as, mobile phones, TV, digital camera, and notebook PC, and so on, and becomes the mainstream of display devices. The LCD device mostly comprises an LCD panel and a backlight; wherein the operation principle of the LCD panel is to dispose liquid crystal (LC) molecules between a color filter (CF) substrate and an array substrate, which are disposed in parallel, with a plurality of electrodes on the two substrates opposite to one another. When a voltage is applied through the electrodes to the LC sandwiched between the two substrates, the arrangement of the LC molecules is changed according to the voltage to display images. However, the indium-tin-oxide (ITO) conductive film formed on the CF substrate may suffer uneven thickness at the edge area, and the voltage difference between the high voltage region and low voltage region is unstable to affect the tilt angle of the LC molecules.

### SUMMARY OF THE INVENTION

The primary object of the present invention is to provide a color filter substrate, LCD panel and LCD device, to address the technical issues of LC tilt angle affected by the unstable voltage caused by ITO conductive film unevenness.

To solve the above problem, the present invention provides a color substrate, which comprises: a substrate, and an ITO conductive film formed on the substrate; trenches being disposed at edge region of the ITO conductive film, the trenches penetrating the ITO conductive film and dividing the ITO conductive film into a first region and a second region, the first and second regions being mutually insulated.

According to an embodiment of the present invention, the trenches are formed by using laser sculpturing.

According to an embodiment of the present invention, the trenches are 5-15 mm from boundary of the edge region of the ITO conductive film.

According to an embodiment of the present invention, the trenches have a shape of curved bars, have different thickness in the first region and the second region, and have an even thickness in the first region.

According to an embodiment of the present invention, a black matrix layer is disposed on the substrate, and the ITO conductive film covers the black matrix layer.

The present invention also provides a liquid crystal display (LCD) panel; which comprises: an array substrate, a color film substrate, and a liquid crystal layer sealed between the array substrate and the color film substrate, the color film substrate comprising a substrate, a black matrix layer formed on the substrate, and an ITO conductive film covering the black matrix layer; trenches being disposed at edge region of the ITO conductive film, the trenches penetrating the ITO conductive film and dividing the ITO conductive film into a first region and a second region, the first and second regions being mutually insulated.

According to an embodiment of the present invention, the trenches are 5-15 mm from boundary of the edge region of the ITO conductive film.

According to an embodiment of the present invention, the trenches have a shape of curved bars, have different thickness in the first region and the second region, and have an even thickness in the first region.

According to an embodiment of the present invention, the LCD panel comprises a non-active area and an active area, the second region of the ITO conductive film and the non-active area are disposed oppositely.

The present invention also provides a liquid crystal display (LCD) device, which comprises: the LCD panel and a backlight source.

The LCD panel of the embodiments of the present invention reduces the resistance of the active area of the conductive film by insulating the uneven part of the edge region of the ITO conductive film on the color film substrate, and is able to ensure that the voltage of the ITO conductive film is not affected, so as to ensure the tilt angle of the liquid crystal.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a schematic view showing the planar structure of the color film substrate according to an embodiment of the present invention.

FIG. 2 is a top view showing the planar structure of the color film substrate in FIG. 1.

FIG. 3 is a schematic showing an embodiment of the trenches of the color film substrate in FIG. 1.

FIG. 4 is a schematic view showing the LCD panel according to the present invention.

### DETAILED DESCRIPTION OF THE PREFERRED EMBODIMENTS

To further explain the technical means and effect of the present invention, the following refers to embodiments and drawings for detailed description. Apparently, the described embodiments are merely some embodiments of the present invention, instead of all embodiments. All other embodiments based on embodiments in the present invention and obtained by those skilled in the art without departing from the creative work of the present invention are within the scope of the present invention.

The terms “comprising” and “having” and any variations thereof appearing in the specification, claims, and drawings of the present application are intended to cover non-exclusive inclusion. For example, a process, method, system, product, or device that includes a series of steps or units is not limited to the listed steps or units, but optionally also includes steps or units not listed, or alternatively, other steps or units inherent to these processes, methods, products or equipment. In addition, the terms “first”, “second” and “third” are used to distinguish different objects, and are not intended to describe a particular order.

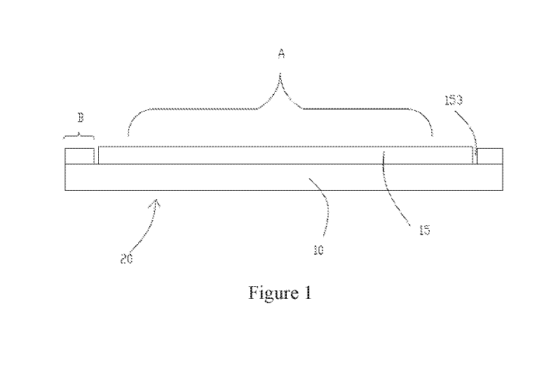

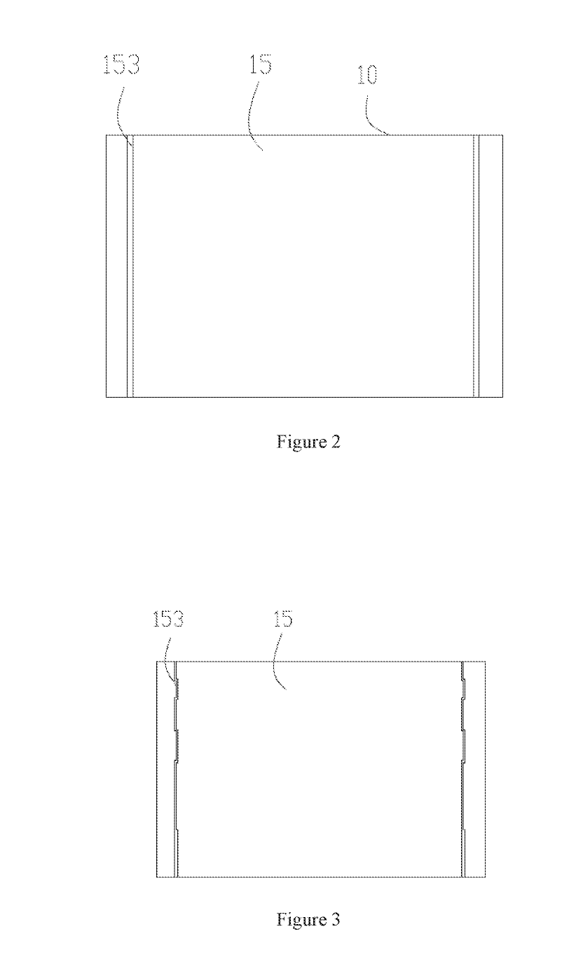

The present invention provides a color substrate, and an LCD panel comprising the color filter substrate. The LCD panel comprises a non-active area and an active area. Refer to FIG. 1. The color filter substrate 20 comprises: a substrate 10, and an ITO conductive film 15 formed on the substrate 20; trenches 153 being disposed at edge region of the ITO conductive film 15, the trenches 153 penetrating the ITO conductive film 15 and dividing the ITO conductive film 15 into a first region A and a second region B. the first and second regions are mutually insulated.

In the present embodiment, the substrate 10 is a transparent glass, which comprises: an edge region and an active region. The active region corresponds to the active area of the LCD panel, and the edge region of the substrate 10 corresponds to the non-active area of the LCD panel. The substrate 10 is disposed with a black matrix on the surface. The ITP conductive film 15 covers the black matrix. The ITO conductive film 15 is formed with ITO material by vacuum sputtering process and patterned by laser sculpturing to form the required ITO pattern. The ITO conductive film 15 comprises a high voltage region and a low voltage region. The trenches 153 are formed by laser sculpturing at the same time as the ITO conductive film is patterned. As such, no additional process is needed and, by ensuring that the trenches are formed according to the defined range during processing, the performance improvement of the ITO conductive film is achieved.

In the present embodiment, the ITO conductive film 15 is divided into the first region A and the second region B, mutually insulated from each other. The first region A corresponds to the active region of the substrate 10, and the second region B corresponds to the edge region of the substrate 10. The high voltage region and the low voltage region of the ITO conductive film of the second region B located at the edge region may suffer unstable voltage because of uneven thickness during film forming, which leads to incomplete mutual insulation and resulting in connection. The trenches 153 are used to separate the high voltage region and the low voltage region of the ITO conductive film of the second region B from the high voltage region and the low voltage region of the active area. As such, when the voltage difference is formed in the active area of the display panel, the stability of the voltage difference is guaranteed to avoid affecting the LC tilt angle.

The trenches 153 are straight trenches with a rectangular or V-shaped cross-section and penetrate the ITO conductive film 15. The locations of the trenches 153 depend on the thickness evenness of the ITO conductive film 15. The ITO conductive film 15 is located at the part of the edge region of the substrate 10 where the thickness starts becoming uneven. In the present embodiment, the distance between the trenches 153 and the boundary of the edge region of the ITO conductive film away from the active region is 5-15 mm.

In other embodiments, as shown in FIG. 3, the trenches 153 are shaped as curved bars. The first region A and the second region B located at both sides of the trenches 153 have different thickness, and the thickness in the first region A is even. For example, the trenches 153 are rectangular teeth shaped, and then the first region located at one side of the trenches 153 is even. In other words, the part of the ITO conductive film with even thickness and having the low voltage region and high voltage region completed insulated is included in the first region so as to guarantee the area size of the ITO conductive film in the first region to further stabilize the voltage difference.

The ITO conductive film 15 of the color film substrate, divided by the trenches 153 into mutually insulated first region A and second region B to separate the high voltage region and the low voltage region of the ITO conductive film in the second region, guarantees the thickness evenness of the ITO conductive film 15 in the first region A of the active region to guarantee the operation performance.

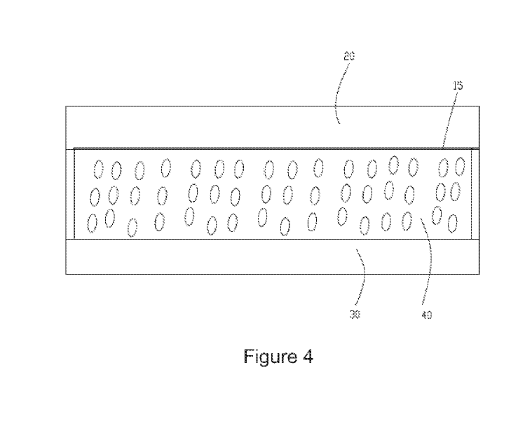

As shown in FIG. 4, the LCD panel comprises an array substrate 30, the color film substrate 20, and a liquid crystal layer 40 sealed between the array substrate 30 and the color film substrate 20. In the present embodiment, the array substrate 30 comprises a TFT device layer and a pixel unit layer and a pixel electrode layer, stacked on the TFT device layer. The black matrix of the color film substrate 20 is for shielding the wiring area of the array substrate. In the LCD panel, the ITO electrode layer on the array substrate 30 and the ITO conductive film 15 inside the first region A form an electric filed and generate a voltage difference in the LC layer 40 to drive the LCD tilting to achieve display. Because the uneven part of the ITO conductive film 15 of the color film substrate 20 is insulated, the resistance of the ITO conductive film is reduced to guarantee the voltage of the ITO conductive film 15 is unaffected, so as to guarantee the LC tilt angle.

The present invention provides an LCD device, which comprises the LCD panel and a backlight source. The backlight source provides a light source to the LCD panel.

It should be noted that each of the embodiments in this specification is described in a progressive manner, each of which is primarily described in connection with other embodiments with emphasis on the difference parts, and the same or similar parts may be seen from each other. For the device embodiment, since it is substantially similar to the method embodiment, the description is relatively simple and the relevant description may be described in part of the method embodiment.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A color film (CF) substrate, comprising: a substrate, and an indium-tin-oxide (ITO) conductive film formed on the substrate; trenches being disposed at edge region of the ITO conductive film, the trenches penetrating the ITO conductive film and dividing the ITO conductive film into a first region and a second region, the first and second regions being mutually insulated.

2. The CF substrate as claimed in claim 1 wherein the trenches are formed by using laser sculpturing.

3. The CF substrate as claimed in claim 1, wherein the trenches are 5-15 mm from boundary of the edge region of the ITO conductive film.

4. The CF substrate as claimed in claim 1, wherein the trenches have a shape of curved bars, have different thickness in the first region and the second region, and have an even thickness in the first region.

5. The CF substrate as claimed in claim 4, wherein a black matrix layer is disposed on the substrate, and the ITO conductive film covers the black matrix layer.

6. A liquid crystal display (LCD) panel, comprising: an array substrate, a color film substrate, and a liquid crystal layer sealed between the array substrate and the color film substrate, the color film substrate comprising a substrate, a black matrix layer formed on the substrate, and an ITO conductive film covering the black matrix layer; trenches being disposed at edge region of the ITO conductive film, the trenches penetrating the ITO conductive film and dividing the ITO conductive film into a first region and a second region, the first and second regions being mutually insulated.

7. The LCD panel as claimed in claim 6, wherein the trenches are 5-15 mm from boundary of the edge region of the ITO conductive film.

8. The LCD panel as claimed in claim 6, wherein the trenches have a shape of curved bars, have different thickness in the first region and the second region, and have an even thickness in the first region.

9. The LCD panel as claimed in claim 6, wherein the LCD panel comprises a non-active area and an active area, the second region of the ITO conductive film and the non-active area are disposed oppositely.

10. A liquid crystal display (LCD) device, comprising: an LCD panel and a backlight source, the LCD panel comprising: an array substrate, a color film substrate, and a liquid crystal layer sealed between the array substrate and the color film substrate, the color film substrate comprising a substrate, a black matrix layer formed on the substrate, and an ITO conductive film covering the black matrix layer; trenches being disposed at edge region of the ITO conductive film, the trenches penetrating the ITO conductive film and dividing the ITO conductive film into a first region and a second region, the first and second regions being mutually insulated.

11. The LCD device as claimed in claim 10, wherein the trenches are 5-15 mm from boundary of the edge region of the ITO conductive film.

12. The LCD device as claimed in claim 10, wherein the trenches have a shape of curved bars, have different thickness in the first region and the second region, and have an even thickness in the first region.

13. The LCD device as claimed in claim 10, wherein the LCD panel comprises a non-active area and an active area, the second region of the ITO conductive film and the non-active area are disposed oppositely.
